(19) United States
(12) Patent Application Publication
(10) Pub. No.: US 2025/0332984 A1
(43) Pub. Date: Oct. 30, 2025

(54) DETERMINING THE DYNAMIC PITCH ANGLE OF A VEHICLE FOR AUTOMATIC HEADLAMP BEAM HEIGHT ADJUSTMENT

(71) Applicant: Ford Global Technologies, LLC, Dearborn, MI (US)

(72) Inventors: Matthias Christian Reiter, Aachen (DE); Tonny Cloots, Frechen (DE); Jannis Koenkes, Bonn (DE)

(73) Assignee: Ford Global Technologies, LLC, Dearborn, MI (US)

(21) Appl. No.: 19/175,081

(22) Filed: Apr. 10, 2025

(30) Foreign Application Priority Data
Apr. 29, 2024 (DE) 102024111963.2

(51) Int. Cl. B60Q 1/115; G01B 5/24

(52) U.S. Cl. CPC B60Q 1/115; G01B 5/24; B60Q 2200/30

(57) ABSTRACT

A method for adjusting a beam height of at least one headlamp of a vehicle. The steps include determining a setting position of at least one headlamp, the load pitch angle of the vehicle and the dynamic pitch angle of the vehicle by detecting signals by using at least one acceleration sensor, and detecting the operating state of the trailer coupling. If it is detected that a trailer is coupled to the vehicle, determining the dynamic pitch angle based on detected signals for determining the dynamic pitch angle and at least one correction parameter that represents an influence of the trailer on the dynamic pitch angle of the vehicle, determining a deviation of the pitch angle of the vehicle from the setting position and thus a resulting deviation of at least one headlamp from the setting position and adjusting the setting of at least one headlamp.

### CROSS-REFERENCE TO RELATED APPLICATION

This application claims foreign priority benefits under 35 U.S.C. § 119 (a)-(d) to German Application No. 102024111963.2 filed Apr. 29, 2024, which is hereby incorporated by reference in its entirety.

### FIELD OF THE DISCLOSURE

The present disclosure generally relates to a method for determining the dynamic pitch angle of a vehicle for automatic beam height adjustment of at least one headlamp of the vehicle, and a method and a device for adjusting the beam height of at least one headlamp.

### BACKGROUND OF THE DISCLOSURE

Automatic headlamp beam height adjustment systems typically consider the current load pitch angle of the vehicle with respect to the road surface as an input variable. A change in the pitch angle can occur as a result of the driving style or as a result of loading or unloading the vehicle, for example, a car with a loaded trunk. When the load pitch angle changes, the headlamps can be readjusted, that is corrected upwards or downwards with respect to their beam angle, in order to reduce illuminating the oncoming traffic, for example as a result of headlamps set too high, or reducing the visibility range, for example as a result of headlamps set too low.

The pitch angle of a vehicle is typically determined using two mechanical level sensors, with a first level sensor being mounted on the front axle and a second level sensor mounted on the rear axle. The level sensors provide information about a change in the suspension height, wherein an electrical output signal from the level sensor changes depending on the suspension height of the vehicle. This output signal can be used by a control unit, e.g., a headlamp control module (HCM), to calculate the pitch angle and to control a stepper motor within the headlamp for its adjustment. In combination with knowledge of the wheelbase, a direct, accurate and rapid method for determining the change in the pitch angle of a vehicle, for example due to additional loading or other factors, is thus available. It would be desirable to replace the previously described solution based on mechanical sensors by suitable alternatives.

Known methods are capable of determining an average pitch angle with respect to the road surface by use of images acquired by a front-facing camera. The use of acceleration signals for determining or estimating the dynamic pitch angle, such as by using function tables, for the purpose of headlamp beam height adjustment is also generally known. A trailer coupled to the vehicle can affect the pitching behavior of the vehicle. A headlamp beam adjustment system that uses a dynamic model to calculate or estimate the dynamic pitching motion based on the longitudinal acceleration may rely on a behavior of the vehicle pitch angle predicted by the model.

It would be desirable to provide an advantageous method for determining the dynamic pitch angle of a vehicle having a trailer coupling for automatic headlamp beam height adjustment and an advantageous method for headlamp beam height adjustment.

### SUMMARY OF THE DISCLOSURE

According to a first aspect of the present disclosure, a method for determining a dynamic pitch angle of a vehicle for automatic beam height adjustment of at least one headlamp of the vehicle may include a trailer coupling, at least one acceleration sensor and at least one operating state detector for detecting an operating state of the trailer coupling of the vehicle. The method may include the steps of detecting signals for determining the dynamic pitch angle by using the at least one acceleration sensor, detecting the operating state of the trailer coupling and, if it is detected that a trailer is coupled to the vehicle, determining the dynamic pitch angle based on the detected signals for determining the dynamic pitch angle and at least one correction parameter that represents an influence of the trailer on the dynamic pitch angle of the vehicle.

Embodiments of the first aspect of the present disclosure can include any one or a combination of the following features:
the at least one correction parameter is determined by using at least one of a lookup table, a curve, and a mapping function;
based on the signals for determining the dynamic pitch angle detected by using the at least one acceleration sensor, an output value of the dynamic pitch angle is determined which is adjusted based on the at least one correction parameter;
the correction parameter is formed as a variable which is multiplied by the output value;
the correction parameter is formed as a variable which is added to the output value;
a trailer loading state device for determining the loading state of a trailer coupled to the vehicle, by use of which the loading state of the trailer is determined with the correction parameter being determined based on the determined loading state of the trailer;
the trailer loading state device for determining the loading status of a trailer is coupled to the vehicle comprising a human-machine interface and/or a camera;
a device for determining the motion state of a trailer is coupled to the vehicle, by use of which the motion state of the trailer is determined with the correction parameter being determined based on the determined motion state of the trailer;
the steps are executed by a computer program comprising commands which, during the execution of the program by a computer, cause the computer to implement the method;
the computer program is stored on a computer-readable data carrier; and
a data carrier signal transmits the computer program.

According to a second aspect of the present disclosure, a method for adjusting a beam height of at least one headlamp of a vehicle having a trailer coupling may include the steps of determining a setting position of the at least one headlamp, determining a load pitch angle of the vehicle, and determining a dynamic pitch angle of the vehicle. The dynamic pitch angle may be determined by detecting signals for determining the dynamic pitch angle by using at least one acceleration sensor, detecting an operating state of the trailer coupling and, if it is detected that a trailer is coupled to the vehicle, determining the dynamic pitch angle based on the detected signals for determining the dynamic pitch angle and at least one correction parameter that represents an influence of the trailer on the dynamic pitch angle of the vehicle. Further steps may include determining a deviation of the dynamic pitch angle of the vehicle from the setting position and thus a resulting deviation of the at least one headlamp from the setting position and adjusting the setting of the at least one headlamp.

Embodiments of the second aspect of the present disclosure can include any one or a combination of the following features:
the at least one correction parameter is determined by using at least one of a lookup table, a curve, and a mapping function;
based on the signals for determining the dynamic pitch angle detected by using the at least one acceleration sensor, an output value of the dynamic pitch angle is determined, which is adjusted based on the at least one correction parameter.
a trailer loading state device for determining the loading state of a trailer is coupled to the vehicle, by use of which the loading state of the trailer is determined with the correction parameter being determined based on the determined loading state of the trailer;
the trailer loading state device for determining the loading status of a trailer coupled to the vehicle comprises a human-machine interface and/or a camera; and
a device for determining the motion state of a trailer is coupled to the vehicle, by use of which the motion state of the trailer is determined with the correction parameter being determined based on the determined motion state of the trailer.

A third aspect of the present disclosure is a method for a device for beam height adjustment of at least one headlamp of a vehicle with a trailer coupling. The vehicle or the device for beam height adjustment may comprise at least one acceleration sensor and an operating state detector for detecting the operating state of the trailer coupling of the vehicle. The device for beam height adjustment may be designed to receive data from the at least one acceleration sensor to receive data from the operating state detector for detecting the operating state of the trailer coupling of the vehicle. The method steps may include determining a setting position of the at least one headlamp, determining a load pitch angle of the vehicle and determining a dynamic pitch angle of the vehicle by detecting signals for determining the dynamic pitch angle by using the at least one acceleration sensor. The method steps may further include detecting the operating state of the trailer coupling and, if it is detected that a trailer is coupled to the vehicle, determining the dynamic pitch angle based on the detected signals for determining the dynamic pitch angle and at least one correction parameter that represents an influence of the trailer on the dynamic pitch angle of the vehicle, determining a deviation of the dynamic pitch angle of the vehicle from the setting position and thus a resulting deviation of the at least one headlamp from the setting position and adjusting the setting of the at least one headlamp.

Embodiments of the third aspect of the present disclosure can include any one or a combination of the following features:
the device comprises a trailer loading state device for determining the loading status of a trailer coupled to the vehicle, and is designed to receive data from the device for determining the loading state of a trailer coupled to the vehicle and to carry out a method; and
the device comprises a device for determining the motion state of a trailer coupled to the vehicle, and is designed to receive data from the device for determining the motion state of a trailer coupled to the vehicle and to carry out a method.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a flow chart illustrating a method for determining the dynamic pitch angle of a vehicle according to one embodiment;

FIG. 2 is a flow chart illustrating a method for beam height adjustment according to one embodiment; and

FIG. 3 is a schematic block diagram of a motor vehicle having a device according to the disclosure for beam height adjustment.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

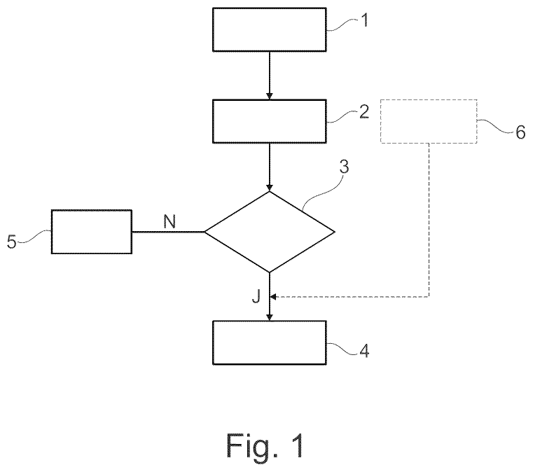

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a method of determining a dynamic pitch angle of a vehicle for automatic headlight range control of at least one headlamp of the vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The general term pitch angle refers to the instantaneous angle of the vehicle above the ground. This varies rapidly and is influenced both by the loading of the vehicle, the vehicle longitudinal dynamics, in particular braking, acceleration, as well as uphill and downhill due to additional power demand, as well as by random road unevenness. In this disclosure, the factory state or calibration state or the state of an unladen vehicle is defined as a state with a pitch angle of zero degrees. All other angles describe a deviation from the factory state or from the unladen state.

An averaged pitch angle is understood to mean the measuring angle of a system that determines an averaged pitch angle when the vehicle is driving (e.g. a camera that determines a horizon angle via a series of images). The load pitch angle is the quasi-static component of the pitch angle, which depends only on the loading, but not on the driving situation. It corresponds to the angle that is set when the vehicle is at a standstill on a horizontal surface. The dynamic pitch angle refers to the current, i.e., the instantaneous, rapidly varying, deviation of the pitch angle from the load pitch angle, in other words the portion of the pitch angle that depends on the driving situation (braking, accelerating, uphill, downhill).

To determine the dynamic pitch angle, the longitudinal acceleration of the vehicle can be measured, which usually correlates very well with the dynamic pitch angle, since the dynamic pitch angle is mainly caused by acceleration forces that act on a predominantly linearly spring-mounted system.

FIG. 1 shows a method having steps according to the disclosure for determining the dynamic pitch angle of a motor vehicle 20. The motor vehicle 20 comprises a trailer coupling 19, at least one acceleration sensor 24 and at least one means for detecting the operating state of the trailer coupling 19.

In step 1, signals for determining the dynamic pitch angle are detected by use of the at least one acceleration sensor. In step 2, the operating state of the trailer coupling is detected. In step 3, it is checked whether a trailer is coupled to the vehicle. If this is not the case, a regular determination of the dynamic pitch angle is made in step 5 based on the signals acquired for determining the dynamic pitch angle, or the method jumps back to step 1. If it is detected in steps 2 and 3 that a trailer is coupled to the vehicle, then in step 4, the dynamic pitch angle is determined based on the signals detected to determine the dynamic pitch angle and at least one correction parameter that represents the influence of the trailer on the dynamic pitch angle of the vehicle. Optionally, in step 6, the motion state and/or the loading state of the trailer can be determined, e.g., detected, and taken into account when determining or calculating the correction parameter. In other words, the correction parameter can be determined, in particular selected or estimated or calculated, based on the determined state of motion and/or the determined loading state of the trailer.

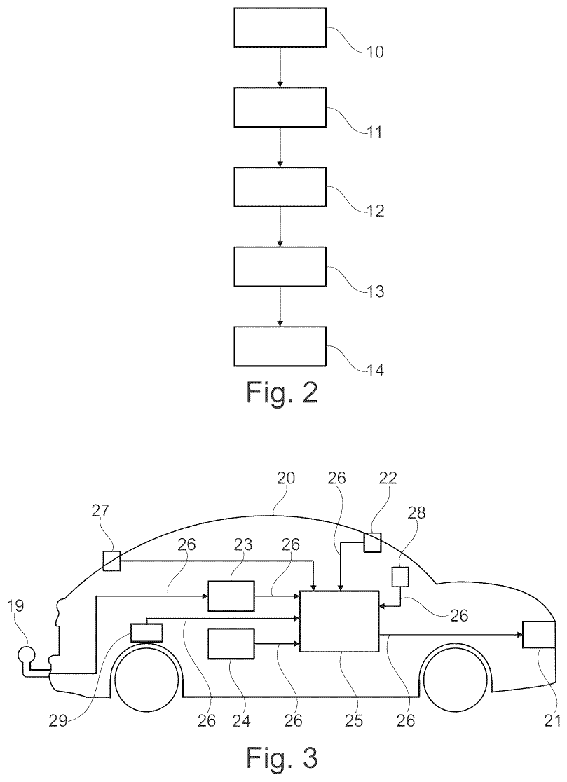

FIG. 2 shows a method having further steps according to the disclosure for beam height adjustment. In step 10, a setting position of the at least one headlamp for controlling the beam height is determined. The prerequisite for this may be an adjustment of the zero angle. Thus, with a nominal basic setting of a stepper motor angle, the headlamp is calibrated as part of the assembly in such a way that a defined light exit gradient is achieved. This means that the headlamp is mechanically and/or optically calibrated (headlamp adjustment). In doing so, a zero angle command can be issued to set the beam height, which this also then moves to. At the same time, the corresponding load pitch angle (reference load angle, zero load angle) can be determined, e.g., in a reference station with known targets.

In step 11, the load pitch angle, i.e., the deviation of the pitch angle from the zero loading angle caused by the static loading of the vehicle, is determined. In step 12, the dynamic pitch angle of the vehicle is determined, in particular relative to the load pitch angle determined in step 11, for example using a method explained with reference to FIG. 1. In step 13, based on the determined load pitch angle and the determined dynamic pitch angle of the vehicle, the deviation of the current pitch angle from the setting position is calculated and thus the resultant deviation of the headlamp from the setting position. In this context, a new setpoint angle can be defined. Then, in step 14, the setting, in particular the light exit angle of the at least one headlamp, is adjusted according to the determined deviation such that the defined, new target angle is activated.

FIG. 3 shows one example of a motor vehicle 20 according to the disclosure having a device 25 for beam height adjustment. The motor vehicle 20 comprises at least one trailer coupling 19, at least one headlamp 21, for example a front headlamp, and at least one acceleration sensor 24. Furthermore, the vehicle 20 or the device for headlamp beam height adjustment 25 comprises a trailer coupling detector 23 for detecting the operating state of the trailer coupling 19. The beam height adjustment device 25 is designed to receive data from the acceleration sensor 24 and the trailer coupling detector 23 for determining the operating state of the trailer coupling 19, and to carry out a method according to the disclosure for beam height adjustment, for example a method shown and described with reference to FIG. 1.

Advantageously, the vehicle 20 comprises a trailer motion state detector 27, e.g., a camera, for determining the motion state of the trailer 19. In addition or alternatively, the vehicle 20 may comprise a trailer loading state detector for determining the loading state of the trailer 19. In this case, this can be a camera 27. In the variant shown in FIG. 3, the camera 27 is designed to determine the motion state and/or the loading state of the trailer 19. The optional trailer loading state detector for determining the loading state of the trailer 19 can also include a human machine interface (HMI) 28 or be designed as an HMI 28, via which a user can make inputs to the current loading state.

Optionally, the vehicle 20 or the device for beam height adjustment 25 can comprise a vehicle pitch angle detector 22 for determining an averaged pitch angle of the vehicle, in particular an environment detection device 22, for example in the form of a camera which may be mounted in particular on a windscreen. The device for beam height adjustment 25 is optionally designed to receive data from the vehicle pitch angle detector 22 for determining an averaged pitch angle of the motor vehicle 20 and to carry out a method according to the disclosure for beam height adjustment, for example, a method shown and described with reference to FIG. 1.

Optionally, the vehicle 20 or the device for beam height adjustment 25 may include at least one axle sensor 29, preferably on the rear axle, for determining a load pitch angle. The device for beam height adjustment 25 is optionally designed to receive data from the at least one axle sensor 29 and to carry out a method according to the disclosure for beam height adjustment, for example, a method shown and described with reference to FIG. 1.

The data transmission is indicated in FIG. 3 by arrows with the reference sign 26. For setting, in particular for controlling or adjusting the beam height of the headlamp 21, the beam height adjustment device 25 transmits corresponding data to a control unit, for example for controlling a stepper motor within the headlamp 21. The control unit may include digital circuitry such as a processor, for example.

The method according to the disclosure for determining, in particular estimating, the dynamic pitch angle of a vehicle for automatic beam height adjustment of at least one headlamp, for example a front headlamp, of the vehicle relates to a vehicle which comprises at least one acceleration sensor, a trailer coupling and at least one operating state detector for detecting the operating state of the trailer coupling of the vehicle.

The method according to the disclosure comprises the following steps for determining the dynamic pitch angle are detected by use of the at least one acceleration sensor. The operating state of the trailer coupling is detected. If it is detected that a trailer is coupled to the vehicle, the dynamic pitch angle is determined based on the detected signals for determining the dynamic pitch angle and at least one correction parameter, such as a correction value or correction factor that represents an influence of the trailer on the dynamic pitch angle of the vehicle.

The method according to the disclosure has the advantage that it takes into account the possible influence of a trailer coupled to the vehicle in the context of determining the dynamic pitch angle of a vehicle for automatic beam height adjustment. It thus allows an enhancement in the reliability of the automatic beam height adjustment system. In particular, elevated illumination of oncoming traffic or a temporarily too short visibility range caused by a trailer can be effectively reduced or prevented.

The method according to the disclosure also has the advantage that a dynamic pitch angle can be reliably determined without the use of the level sensors described above. Thus, in connection with a headlamp beam height adjustment, the use of level sensors may be omitted in the future. This can enhance efficiencies of the level sensor itself and its installation and maintenance.

The at least one correction parameter can be determined, in particular calculated or estimated, for example by use of a lookup table and/or a curve and/or a mapping function. These variants allow for a simple, reliable and efficient consideration of the possible influence of a trailer on the dynamic pitch angle.

In an exemplary variant, based on the signals for determining the dynamic pitch angle detected by use of the at least one acceleration sensor, an output value of the dynamic pitch angle can be determined, in particular calculated or estimated, which is adjusted or corrected by use of the at least one correction parameter. This variant has the advantage that it allows simple retrofitting or extension of existing systems. The correction parameter can be formed as a quantity, such as a factor by which the output value is multiplied. Multiplication here also includes division. In addition or alternatively, the correction parameter may be formed as a variable which is added to the output value or in the case of a negative sign subtracted from the output value. In all variants, the correction parameter can be designed as a specific or defined or determinable or definable correction value.

Optionally, the vehicle may include a trailer loading state device for determining the loading state of a trailer coupled to the vehicle, by use of which the loading state of the trailer can be determined within the context of the method. The correction parameter can be determined based on the determined loading state of the trailer, e.g., adjusted or selected or defined or calculated or estimated. This variant offers enhanced accuracy in the determined dynamic pitch angle. The trailer loading state device for determining the loading state of a trailer coupled to the vehicle can in particular comprise an HMI and/or a camera, e.g. a rear view camera or backward-facing camera. Using the HMI, a user can make entries relating to the current loading of the trailer. These can then be used as part of determining the correction parameter.

In a further, advantageous variant the vehicle comprises a trailer motion detector for determining the motion state of a trailer coupled to the vehicle, by use of which the motion state of the trailer can be determined. The correction parameter can be determined based on the determined motion state of the trailer, e.g., adjusted or selected or defined or calculated or estimated. This has the advantage that unevenness of the road surface or vibrations of the trailer caused by other means can be detected and their influence on the dynamic pitch angle of the vehicle can be reliably taken into account. The trailer motion detector for determining the motion state of a trailer coupled to the vehicle can be, for example, a camera or comprise such a camera.

The method according to the disclosure for adjusting the beam height of at least one headlamp, for example a front headlamp, of a vehicle comprises the following steps. Firstly, a setting position of the at least one headlamp is determined. The prerequisite for this is an adjustment of the zero angle. Thus, with a nominal basic setting of a stepper motor angle, the headlamp is calibrated as part of the assembly in such a way that a defined light exit gradient is achieved. Normally, the headlamp is set (by activation) to a “zero position” at the end of the production line. Since the headlamps as a component are subject to large mechanical tolerances, the angle is then corrected by means of adjusting screws (or electronic activation) so that the light is emitted at a fixed angle. This process is also known as “adjustment” or “aiming” and provides the setting position as a prerequisite for any further compensation. Subsequent beam height adjustment or “leveling” identifies changes in the angle between the vehicle and the ground and compensates for the fixed light exit angle or the required deviation from the setting position.

Subsequently to the determination of the setting position of the at least one headlamp, the load pitch angle is determined and the dynamic pitch angle of the vehicle is determined by use of a method according to the disclosure described above. In a next step, the deviation of the pitch angle of the vehicle from the setting position and thus the resulting deviation of the at least one headlamp from the setting position is determined. In particular, a new setpoint angle can be defined. The setting, in particular the light output angle, of the at least one headlamp is then adjusted according to the determined deviation. In particular, the new, defined setpoint angle can be activated. The beam height can be adjusted by mechanically rotating a pivot frame by the required angle, which may be controlled by a stepper motor. With high-resolution pixel headlamps, it is also possible to switch pixel rows on or off so that no light is emitted above the desired light-dark limit. In other words, a change in the light output angle is compensated.

The load pitch angle can be determined by use of a camera and/or by use of an axle sensor, preferably a rear axle sensor.

The method according to the disclosure for beam height adjustment has the features and advantages already described in connection with the method according to the disclosure for determining the dynamic pitch angle of the vehicle.

The device according to the disclosure for adjusting the beam height of at least one headlamp of a vehicle with a trailer coupling relates to a device or a vehicle which comprises at least one acceleration sensor and an operating state detector for recording, in particular detecting, the operating state of the trailer coupling of the vehicle. The device according to the disclosure for beam height adjustment is designed to receive data from the at least one acceleration sensor and the operating state detector for detecting the operating state of the trailer coupling of the vehicle, and to carry out a previously described method according to the disclosure for beam height adjustment. The device according to the disclosure for beam height adjustment has the features and advantages already mentioned in connection with the method according to the disclosure.

In a further variant, the device for beam height adjustment may comprise at least one device for determining an averaged pitch angle, in particular an environment detection device, for example a camera, e.g. a front-mounted camera, and be designed to receive data from the means for determining an averaged pitch angle of the vehicle and to carry out a method according to the disclosure. The device for determining an averaged pitch angle may be designed to detect the road ahead of the vehicle and/or to determine an averaged pitch angle of the vehicle. This further enhances the accuracy and reliability of the determination of the dynamic pitch angle and the headlamp beam height adjustment.

The device for beam height adjustment may advantageously comprise a trailer loading state device for determining the loading state of a trailer coupled to the vehicle, and be designed to receive data from the trailer loading state device for determining the loading state of a trailer coupled to the vehicle and to carry out a method described above. This has the advantage that the respective loading state of the trailer can be taken into account during the headlamp beam height adjustment, which contributes to improving the reliability of the beam height adjustment.

The device for beam height adjustment may advantageously comprise a device for determining the motion state of a trailer coupled to the vehicle, and be designed to receive data from the device for determining the motion state of a trailer coupled to the vehicle and to carry out a method described above. As mentioned above, this allows the effects of trailer vibrations, e.g., vibrations due to uneven road areas, on the pitching behavior of the vehicle to be reliably and efficiently taken into account when determining the dynamic pitch angle.

The vehicle according to the disclosure comprises a device for beam height adjustment described above. The vehicle has the advantages already described. The vehicle can be an electric vehicle or a hybrid electric vehicle (HEV). The vehicle can be a motor vehicle, such as a passenger car, a truck, a bus, a minibus, a motorcycle or a moped, for example.

The computer-implemented method according to the disclosure comprises commands, which during the execution of the program by a computer cause the computer to carry out a method according to the disclosure described above. The computer program product according to the disclosure comprises commands, which during the execution of the program by a computer cause the computer to carry out a method according to the disclosure described above. The computer program product according to the disclosure may be stored on the computer-readable data carrier according to the disclosure. The data carrier signal according to the disclosure transmits the computer program product according to the disclosure. The computer-implemented method according to the disclosure, the computer program product according to the disclosure, the computer-readable data carrier according to the disclosure, and the data carrier signal according to the disclosure have the above-mentioned features and advantages.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A method for determining a dynamic pitch angle of a vehicle for automatic beam height adjustment of at least one headlamp of the vehicle, wherein the vehicle comprises a trailer coupling, at least one acceleration sensor and at least one operating state detector for detecting an operating state of the trailer coupling of the vehicle, wherein the method comprises the following steps:
detecting signals for determining the dynamic pitch angle by using the at least one acceleration sensor;
detecting the operating state of the trailer coupling; and
if it is detected that a trailer is coupled to the vehicle, determining the dynamic pitch angle based on the detected signals for determining the dynamic pitch angle and at least one correction parameter that represents an influence of the trailer on the dynamic pitch angle of the vehicle.

2. The method according to claim 1, wherein the at least one correction parameter is determined by using at least one of a lookup table, a curve, and a mapping function.

3. The method of claim 1, wherein based on the signals for determining the dynamic pitch angle detected by using the at least one acceleration sensor, an output value of the dynamic pitch angle is determined, which is adjusted based on the at least one correction parameter.

4. The method according to claim 3, wherein the correction parameter is formed as a variable which is multiplied by the output value.

5. The method according to claim 3, wherein the correction parameter is formed as a variable which is added to the output value.

6. The method according to claim 1, further comprising a trailer loading state device for determining the loading state of a trailer coupled to the vehicle, by use of which the loading state of the trailer is determined, the correction parameter being determined based on the determined loading state of the trailer.

7. The method according to claim 6, wherein the trailer loading state device for determining the loading status of a trailer coupled to the vehicle comprises a human-machine interface and/or a camera.

8. The method according to claim 1, further comprising a device for determining the motion state of a trailer coupled to the vehicle, by use of which the motion state of the trailer is determined, the correction parameter being determined based on the determined motion state of the trailer.

9. The method according to claim 1, wherein the steps are executed by a computer program comprising commands which, during the execution of the program by a computer, cause the computer to implement the method.

10. The method according to claim 9, wherein the computer program is stored on a computer-readable data carrier.

11. The method according to claim 10, wherein a data carrier signal transmits the computer program.

12. A method for adjusting a beam height of at least one headlamp of a vehicle having a trailer coupling, the method comprising the following steps:
determining a setting position of the at least one headlamp;
determining a load pitch angle of the vehicle;
determining a dynamic pitch angle of the vehicle by:
detecting signals for determining the dynamic pitch angle by using at least one acceleration sensor;
detecting an operating state of the trailer coupling; and
if it is detected that a trailer is coupled to the vehicle, determining the dynamic pitch angle based on the detected signals for determining the dynamic pitch angle and at least one correction parameter that represents an influence of the trailer on the dynamic pitch angle of the vehicle;
determining a deviation of the dynamic pitch angle of the vehicle from the setting position and thus a resulting deviation of the at least one headlamp from the setting position; and
adjusting the setting of the at least one headlamp.

13. The method according to claim 12, wherein the at least one correction parameter is determined by using at least one of a lookup table, a curve, and a mapping function.

14. The method of claim 13, wherein based on the signals for determining the dynamic pitch angle detected by using the at least one acceleration sensor, an output value of the dynamic pitch angle is determined, which is adjusted based on the at least one correction parameter.

15. The method according to claim 12, further comprising a trailer loading state device for determining the loading state of a trailer coupled to the vehicle, by use of which the loading state of the trailer is determined, the correction parameter being determined based on the determined loading state of the trailer.

16. The method according to claim 15, wherein the trailer loading state device for determining the loading status of a trailer coupled to the vehicle comprises a human-machine interface and/or a camera.

17. The method according to claim 12, further comprising a device for determining the motion state of a trailer coupled to the vehicle, by use of which the motion state of the trailer is determined, the correction parameter being determined based on the determined motion state of the trailer.

18. A device for beam height adjustment of at least one headlamp of a vehicle with a trailer coupling, wherein the vehicle or the device for beam height adjustment comprises at least one acceleration sensor and an operating state detector for detecting the operating state of the trailer coupling of the vehicle, wherein the device for beam height adjustment is designed to receive data from the at least one acceleration sensor, to receive data from the operating state detector for detecting the operating state of the trailer coupling of the vehicle, the device including a method comprising the steps of:
determining a setting position of the at least one headlamp;
determining a load pitch angle of the vehicle;
determining a dynamic pitch angle of the vehicle by detecting signals for determining the dynamic pitch angle by using the at least one acceleration sensor, detecting the operating state of the trailer coupling and, if it is detected that a trailer is coupled to the vehicle, determining the dynamic pitch angle based on the detected signals for determining the dynamic pitch angle and at least one correction parameter that represents an influence of the trailer on the dynamic pitch angle of the vehicle;
determining a deviation of the dynamic pitch angle of the vehicle from the setting position and thus a resulting deviation of the at least one headlamp from the setting position; and
adjusting the setting of the at least one headlamp.

19. The device according to claim 18, wherein the device comprises a trailer loading state device for determining the loading status of a trailer coupled to the vehicle, and is designed to receive data from the device for determining the loading state of a trailer coupled to the vehicle and to carry out a method.

20. The device according to claim 19, wherein the device comprises a device for determining the motion state of a trailer coupled to the vehicle, and is designed to receive data from the device for determining the motion state of a trailer coupled to the vehicle and to carry out a method.
